(19) United States
(12) Patent Application Publication
(10) Pub. No.: US 2010/0208351 A1
(43) Pub. Date: Aug. 19, 2010

(54) SELECTIVE AND ORIENTED ASSEMBLY OF PLATELET MATERIALS AND FUNCTIONAL ADDITIVES

(76) Inventors: Michael R. NOFI, Rohnert Park, CA (US); Patrick Laden, Petaluma, CA (US); Charles T. Markantes, Santa Rosa, CA (US); Wilfred C. Kittler, JR., Santa Rosa, CA (US); Paul G. Coombs, Santa Rosa, CA (US)

Correspondence Address: Pequignot + Myers LLC, 140 Marine View Avenue, Suite 220, Solana Beach, CA, 92075, US

(21) Appl. No.: 12/727,205

(22) Filed: Mar. 18, 2010

Related U.S. Application Data
(63) Continuation-in-part of application No. 11/278,600, filed on Apr. 4, 2006.
Application No. 11/278,600 is a continuation-in-part of application No. 11/313,165, filed on Dec. 20, 2005, now Pat. No. 7,604,855.
Application No. 11/313,165 is a continuation-in-part of application No. 11/022,106, filed on Dec. 22, 2004, now Pat. No. 7,517,578.
Application No. 11/022,106 is a continuation-in-part of application No. 10/386,894, filed on Mar. 11, 2003, now Pat. No. 7,047,883.
Application No. 11/278,600 is a continuation-in-part of application No. 11/028,819, filed on Jan. 4, 2005, now Pat. No. 7,300,695.
Application No. 11/028,819 is a continuation-in-part of application No. 10/243,111, filed on Sep. 13, 2002, now Pat. No. 6,902,807.
(60) Provisional application No. 60/777,086, filed on Feb. 27, 2006.
(60) Provisional application No. 60/668,852, filed on Apr. 6, 2005.
(60) Provisional application No. 60/410,546, filed on Sep. 13, 2002.
(60) Provisional application No. 60/410,547, filed on Sep. 13, 2002.
(60) Provisional application No. 60/396,210, filed on Jul. 15, 2002.
(60) Provisional application No. 61/161,528, filed on Mar. 19, 2009.

(51) Int. Cl. G02B 5/28; B05D 1/36; B29C 39/00; B32B 38/10; B32B 5/16

(52) U.S. Cl. 359/589; 427/202; 427/203; 264/299; 156/249; 428/323

(57) ABSTRACT

A method of conforming non-ductile flakes to a surface is provided wherein a surface is coated with the non-ductile flakes. A first step of coating at least a portion of the surface with a coating of adhesive or a paint is required and subsequently before the coating cures a plurality of thin film flakes having a non-ductile insulating or semiconductor layer are sprinkled upon the adhesive or paint while it is still tacky. Typically the thin-film flakes have a thickness of between 50 nm and 2,000 nm, and have a length of between 2 microns and 200 microns. The flakes having a non-ductile layer are then burnished upon the surface so as to provide an active layer, which conforms to the surface.

### CROSS-REFERENCE TO RELATED APPLICATION

The present application is a continuation-in-part of U.S. patent application Ser. No. 11/278,600 filed Apr. 4, 2006, which claims priority from U.S. Provisional Patent Application Ser. No. 60/777,086 filed Feb. 27, 2006 and Ser. No. 60/668,852 filed Apr. 6, 2005, and is a continuation-in-part of U.S. patent application Ser. No. 11/313,165 filed Dec. 20, 2005, which is a continuation-in-part of U.S. patent application Ser. No. 11/022,106, filed Dec. 22, 2004, which is a continuation-in-part from U.S. patent application Ser. No. 10/386,894 filed Mar. 11, 2003, which claims priority from U.S. Provisional Patent Application Ser. No. 60/410,546 filed Sep. 13, 2002; from U.S. Provisional Patent Application Ser. No. 60/410,547 filed Sep. 13, 2002; from U.S. Provisional Patent Application Ser. No. 60/396,210 filed Jul. 15, 2002 by the disclosures of which are hereby incorporated in their entirety for all purposes; and U.S. patent application Ser. No. 11/278,600 filed Apr. 4, 2006 is a continuation-in-part of U.S. patent application Ser. No. 11/028,819 filed Jan. 4, 2005 which is a continuation-in-part of U.S. patent application Ser. No. 10/243,111 filed Sep. 13, 2002, issued as U.S. Pat. No. 6,902,807 on Jun. 7, 2005 the disclosures of which are hereby incorporated in their entirety for all purposes.

This application claims priority from U.S. Provisional Patent Application No. 61/161,528 filed Mar. 19, 2009, which is incorporated herein by reference for all purposes.

### FIELD OF THE INVENTION

This invention relates to burnishing of optical effect flakes having a non-metallic layer or a plurality of layers wherein at least one layer is non-metallic, so as to enhance a surface coated with said flakes.

### BACKGROUND OF THE INVENTION

Pigment flakes are used in a variety of applications, such as in paint, inks, textiles, cosmetics, extruded films, plastic castings, and powder coatings. Different types of pigment flakes can provide various, and often striking, visual effects. Color shifting is an example of a visual effect that can be obtained using pigment flakes. The pigment flakes can have an optical interference structure, such as a Fabry-Perot structure or thin-film stack that changes color as the flake is tilted with respect to the viewing angle. Examples of such color-shifting images are used as security features on bank notes, like the U.S. 20-dollar bill, and for decorative purposes on and in a wide variety of consumer items, including vehicles, helmets, eye glass frames, fingernail polish, and cell-phone cases, to name a few. U.S. Pat. No. 6,246,253 in the name of Bradley et al., and U.S. Pat. No. 6,545,809 both incorporated herein by reference disclose color shifting interference pigments. However, other examples of optical effect pigment flakes include transmissive, reflective, and absorptive flake pigments and transmissive, reflective and absorptive diffractive flake pigments.

The operating wavelength range for pigment flakes is not limited to the visible spectrum but can extend from the ultraviolet to the infrared wavelength region. By way of example, solar absorbers, hot and cold mirror coatings and enhanced ultraviolet reflector mirrors can also be provided in the form of special effect pigment flakes.

In many applications, flat or essentially planar pigment flakes, and even diffractive substantially planar flakes spread over an object or substrate in a carrier tend to align in a plane of the object, such as the printed paper or substrate, to produce a visual optical effect from the aggregate effect of the individual flakes. For some applications it is not necessary for each flake to be perfectly aligned with each other, or with the plane of the substrate, but suitable optical effects such as enhanced specularity, flop effect, etc. can be obtained when a sufficient portion of the flakes are suitably aligned.

Unfortunately, some operations do not lend themselves to planar alignment of pigment flakes and others actually contribute to the degradation of alignment of flakes that are applied in a generally planar fashion. Therefore, it is desirable to produce objects incorporating pigment flakes with improved planar alignment of the flakes.

U.S. Pat. No. 7,258,900 in the name of Raksha et al. discloses the use of magnetic fields to planarize magnetically alignable flakes relative to a surface. Although this method works as intended, it does have some limitations. For example, when a mixture of flakes in a binder is applied to a surface as slurry, some flakes will cover other flakes and in some instances many more flakes will be used than is necessary to cover the substrate. However, in the method disclosed this is difficult to control for, other than ensuring that the flake loading is kept low enough. Furthermore, flakes are generally controlled for by a magnetic field as described and may have some unwanted tilt.

In the past ductile metallic flakes such as gold leaf and other ductile metals have been planarized by burnishing. U.S. Pat. No. 4,418,099 relates to a non-burnished finish on thin film flakes, obviating expected problems that were believed to occur using burnishing methods.

Standard printing of non-ductile flakes or platelets in ink suffers from the deficiency of having a relatively high pigment loading which prevents optimum lay-down of the platelets upon printing and therefore prevents achievement of maximum chroma. Standard printing results in multiple layers of flakes, with the lower layers not optically active and not providing value.

It is an object of this invention to provide a printed image that can be obtained with these non-ductile flakes with a technique that provides better resolution for fine detail, for example a 0.5 point font, than that obtained for standard printing of equivalent platelets placed in standard ink vehicles such as silk screen and flexographic and printed with the corresponding standard techniques.

It is an object of this invention to provide a method and products wherein flakes having one or more non-metallic non-ductile layers conform to a surface they are burnished upon.

It is also an object of this invention to provide a surface covered with flakes wherein most flakes are optically active and are not completely covered or blanketed by other flakes.

### SUMMARY OF THE INVENTION

In accordance with the invention, there is provided a method of conforming non-ductile flakes to a surface, comprising: coating at least a portion of the surface with a coating of adhesive or a paint; and, applying to the coating before the coating cures, a plurality of thin film flakes having a non-ductile insulating or semiconductor layer, wherein the thin-film flakes have a thickness of between 50 nm and 2,000 nm, and wherein the tin-film flakes have a length of between 2 microns and 200 microns; and, burnishing the plurality of thin-film flakes upon the surface so as to provide an active layer which conforms to the surface. Shaped flakes such as square, hexagonal, or other shaped flakes may also be used to promote coverage and enhanced optical performance.

In accordance with another aspect of the invention, there is provided a coated article comprising: a substrate including an adhesive layer having a coating burnished thereon, wherein the coating comprises a plurality of thin-film flakes upon the adhesive layer wherein the flakes have a non-ductile layer that is a semiconductor or insulating material.

### BRIEF DESCRIPTION OF THE DRAWINGS

In accordance with the invention exemplary embodiments of the invention will now be described in conjunction with the drawings:

FIG. 1 is a cross-sectional view of a substrate coated with an adhesive having flakes dusted upon the adhesive prior to burnishing.

FIG. 2 is a cross-sectional view of the coated substrate of FIG. 1 wherein excess flakes not adhesively bound are blown, brushed, vibrated or wiped away.

FIG. 3 is a cross-sectional view of the coated substrate wherein the adherent flakes are polished or burnished onto the surface to insure intimate contact so as to provide a planar finish.

FIG. 4 is a cross-sectional view of the substrate after the non-ductile flakes have been pressed into the adhesive by burnishing.

FIG. 5 is a cross-sectional view of the substrate showing an embodiment wherein a hot stamped product is manufactured.

FIG. 6 is a cross-sectional view of the adhesive ink printed on a substrate with non-ductile flakes conforming to the radius surface of the ink.

### DETAILED DESCRIPTION

The term burnishing flakes used hereafter is to mean rubbing, polishing or brushing flakes so that they conform to the substrate upon which they are applied.

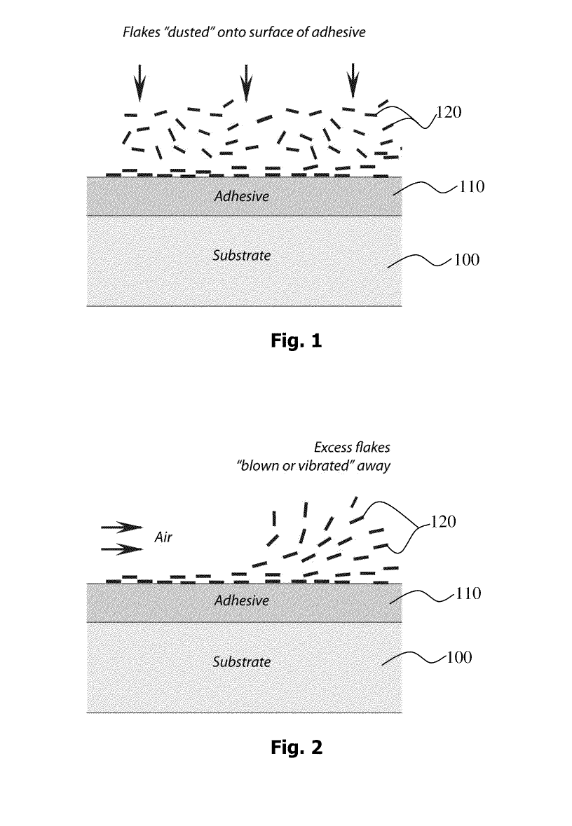

FIGS. 1 through 4 depict various stages of a process that provides a highly oriented specular layer of platelet form flakes upon a substrate which may be a web or an article to be coated. The article need not have a planar surface. For example, helmets, shoes, and other non-planar articles may be coated in this manner wherein the flakes conform to the surface.

Referring now to FIG. 1 substrate 100 supports an adhesive layer 110 coated on at least a portion of the substrate 100. Special effect flakes 120 having a layer of non-ductile material such as semiconductor or insulating material are dusted upon the adhesive layer. The adhesive layer may be applied to the entire substrate or may be applied to predetermined areas for example in a pattern such as a logo or forming other indicia. Craigcote 1029 was found to be a suitable adhesive. The flakes typically have a thickness between 50 nm and 300 nm, although can be thinner, and typically have a length across a surface thereof of between 2 microns and 200 microns.

The adhesive layer 110 must remain tacky for a period of time; during this period, and before the adhesive layer 110 completely cures, the platelet form flakes 120 are applied, preferably by being dusted upon the tacky adhesive layer. Excess flakes 120 which do not stick to the adhesive layer 110 are removed by using pressurized air, vibration or by physically gently dusting off loose flakes as is shown in FIG. 2. These loose flakes are collected for reuse.

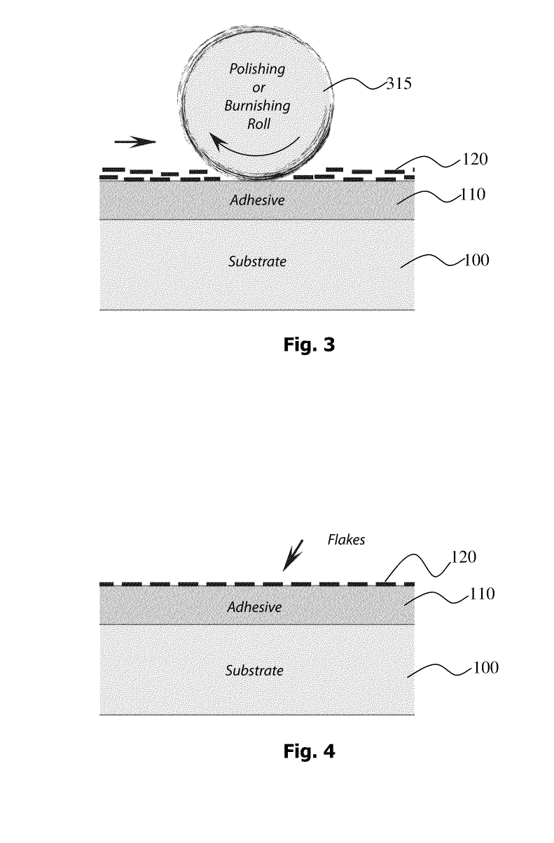

Referring now to FIG. 3 a cloth burnishing roller 315 is shown and is used to apply pressure by rubbing the flakes into the adhesive layer and further into the substrate. The force used in burnishing should be gentle enough so as to not to force flakes deeply into the body of the coating or otherwise damage the surface by excessive force or scratching.

This burnishing action provides a highly mirror like finish and quite unexpectedly does not induce any considerable fracture to the brittle flakes. The burnishing surface method that was used in our experiments is a soft cotton cloth covered rotating wheel, which rotates at an approximately 60 rpm. The amount of force that is applied on the flakes must be sufficient so as to achieve a highly specular surface when flakes having a reflective layer are used, and yet the force must not abrade or damage the surface of the flakes 120. Therefore the minimal amount of force to achieve a highly specular surface is preferred.

FIG. 4 shows the surface of highly oriented flakes burnished upon the substrate. After the flakes conform to the substrate, after sufficient burnishing, a protective topcoat or laminant may be applied to protect the flakes from the environment. The topcoat may be transparent or may contain colorants or other functional additives such as phosphors, fluorescent dyes or other functional materials.

In an alternative embodiment of the invention paint is applied to an object to be coated to serve as the adhesive layer; and, special effect non-ductile flakes are applied as a dry powder to the paint while it is still tacky, before it completely cures. The excess flake material is brushed off so that the base coat is uniformly coated and the adherent flakes are pressed into firm contact with the base coat by burnishing to provide a preferred finish resulting in a highly oriented and specular layer of platelet formed flakes. A protective top coating is subsequently applied which may incorporate other functional components. The result is a more mirror-like coating than can be obtained with the pigment loaded into the carrier vehicle. All or part of an object could be painted in this manner Articles such as plastic containers, cell phones, helmets, etc. can be painted in this manner as well as other articles for which a nearly single layer of platelets that are highly oriented might improve performance. This is a surprisingly good method for applying any rigid platelet form pigment or mixture of platelet form pigments. An advantage of forming a surface of flakes in this manner is color uniformity and the ability to coat shaped objects with highly specular and uniform coatings without requiring vacuum metallization, and economy in the use of the pigment platelets to provide a substantially single layer rather than many overlapping platelets.

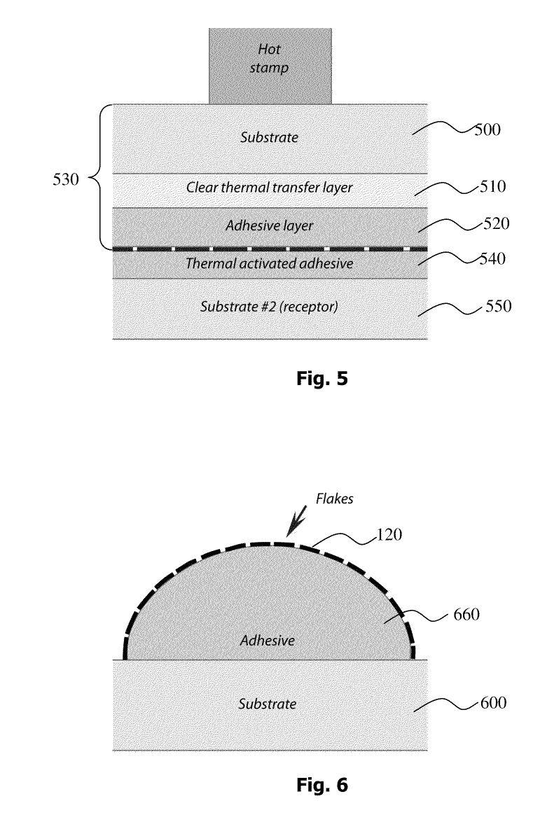

Referring now to FIG. 5 an alternative embodiment of the invention is provided wherein a hot-stamped article is made using the method described heretofore in accordance with this invention. In this instance a burnished construction 530 is applied to a substrate 500 which is first coated with a clear thermal transfer layer 510 followed by a coated adhesive layer 520. The burnished construction which includes 500, 510, and 520 is then coated with a thermally activated adhesive layer 540. This total construction can be subsequently hot stamped transferred onto another substrate 550, such as paper or other plastic films. The final transfer includes everything except the original substrate 500.

Referring to FIG. 6 an alternative embodiment of the invention is provided wherein in this instance the wetting of the adhesive coating 660 can be used to control the cross sectional surface profile of the adhesive coating 660, specifically for text, line or border effects. The pigment flake can be burnished conformally over a radius surface, either spherical or cylindrical in form supported by the substrate 600. This allows the user to control the angular distribution of the reflected light from the printed surface thereby increasing the cone angle of visibility of the “special” effect. Besides controlling the distribution of the reflected light this effect may also be used to create a physical texture to the surface, similar to an embossed texture effect. The adhesive shown is semisolid, even somewhat elastic, and tacky when the pigment is dusted on. It can have a profile that is controlled by its viscosity and thickness as applied. These are choices in adhesive formulation, which depend on the effect desired. The rubbing/burnishing process need only have enough pressure to press the flake into intimate adhesive contact and need not smear the adhesive.

What is claimed is:

1. A method of conforming non-ductile flakes to a surface, comprising:
a) coating at least a portion of the surface with a coating of adhesive or a paint;
b) applying to the coating before the coating cures, a plurality of thin film flakes having a non-ductile insulating or semiconductor layer, wherein the thin-film flakes have a thickness of between 50 nm and 2,000 nm, and wherein the tin-film flakes have a length of between 2 microns and 200 microns; and,
c) burnishing the plurality of thin-film flakes upon the surface so as to provide an active layer which conforms to the surface.

2. A method as defined in claim 1 wherein the step of burnishing includes applying a mechanical polishing step to the flakes wherein pressure is applied to the plurality of flakes in a cyclical fashion.

3. A method as defined in claim 2 wherein the step (b) includes dusting the thin-film flakes onto the binder.

4. A method as defined in claim 3 further comprising coating the thin-film flakes after performing step (c) so as to protect the thin-film burnished flakes.

5. A method as defined in claim 3 further comprising the step of removing excess flakes that have not adhered to the surface.

6. A method as defined in claim 3, wherein the average layer thickness of the coating layer and the layer of burnished flakes upon the substrate is less than 1.3 flakes thick.

7. A method as defined in claim 1 wherein the thin-film flakes having a non-ductile layer are at least 60% reflective, 60% transmissive, or 60% absorptive.

8. A method as defined in claim 3 wherein the thin-film flakes having an insulating or semiconductor layer have an additional layer thereby forming multilayer thin-film flakes.

9. A method as defined in claim 8, wherein the thin-film flakes are multilayer color shifting flakes.

10. A method as defined in claim 8 wherein the thin-film flakes having a non-ductile layer are diffractive flakes.

11. A method as defined in claim 1 wherein the surface is a moving substrate and wherein the burnishing step includes burnishing with a soft napped roller.

12. A method as defined in claim 1 further comprising applying a thermally activated adhesive layer over the burnished thin-film flakes after performing step (c).

13. A method of coating a surface as defined in claim 1 further comprising:
(d) removing the coating and plurality of flakes from the surface to provide a thin hot-stamp layer comprising the coating and the plurality of burnished flakes, after performing step (c).

14. A method of coating a surface as defined in claim 13, further comprising step (e) of providing a layer of thermal activated adhesive between the thin hot-stamp layer and a substrate and hot-stamping the thin-hot stamp layer to the substrate.

15. A coated surface comprising:
a substrate including an adhesive layer having a coating burnished thereon, wherein the coating comprises a plurality of thin-film flakes upon the adhesive layer wherein the flakes have a non-ductile layer that is a semiconductor or insulating material.

16. A coated surface as defined in claim 15 wherein the thin-film flakes have a thickness of between 50 nm and 2,000 nm, and wherein the thin-film flakes have a length of between 2 microns and 200 microns.

17. A coated surface as defined in claim 16, wherein the thin-film flakes are multilayer flakes which are color shifting thin-film flakes providing an observable color shift through thin film interference.

18. A coated surface as defined in claim 16 wherein the coating has an average thickness than is less than 1.5 flakes thick.

19. A coated surface formed by the method of claim 1.
